(19) United States
(12) Patent Application Publication
(10) Pub. No.: US 2011/0283792 A1
(43) Pub. Date: Nov. 24, 2011

(54) Sphere with Velocity Measurement Function

(76) Inventor: Wen-Hsuan Tung, Sanchon City (TW)

(21) Appl. No.: 12/783,747

(22) Filed: May 20, 2010

(51) Int. Cl. G01P 1/02; G01P 3/42

(52) U.S. Cl. 73/494; 324/160

(57) ABSTRACT

A sphere with velocity measurement function comprises a sphere and a velocity measuring device arranged in the sphere, the velocity measuring device comprises a base body, a speedometer and a power supply, the speedometer and the power supply are used for operation and control; the speedometer uses an approach capacitor sensor as a switch of a trigger circuit, the approach capacitor sensor comprises a sensing plate electrode, sensing plate electrode contacts and a conductive ink layer, the sensing plate electrode is arranged on the base body, the conductive ink layer is coated on the inner surface of the sphere, and the sensing plate electrode contacts are arranged in the conductive ink layer; when the base body is placed in the sphere, the conductive ink layer contacts the sensing plate electrode; the present invention also comprises a display screen for displaying results, the display screen transmits data with the speedometer a wire or wireless way; and the approach capacitor sensor is not influenced by the external force, reacts quickly, can obtain accurate measurement results and improve measurement accuracy.

### FIELD OF THE INVENTION

The invention relates to the technical field of sports sphere velocity measurement, in particular to a sphere with accurate velocity measurement function.

### BACKGROUND OF THE INVENTION

The invention patent of Chinese Patent No. 200320119702.9 discloses a velocity measuring device for sports equipment, which is realized by the following technical scheme: the velocity measuring device is mainly composed of a base body arranged in sports equipment, a circuit board used as operation and control and an LCD are arranged in the base body, and the LCD appears on the surface of the sports equipment; and the circuit board uses a centrifugal switch or a vibration switch, or the combination of the vibration switch or the centrifugal switch as a circuit trigger. The velocity measuring device calculates running time of a measured object by the vibration switch, the centrifugal switch or the combination of the vibration switch and the centrifugal switch, calculates the velocity by an integrated circuit, and directly displays the velocity on the object by the LCD. By installing the velocity measuring device on a baseball, after people throw out the baseball, the baseball moves off the hand, the vibration switch or the centrifugal switch in the velocity measuring device are triggered, and the velocity measuring device begins to count time; when the baseball falls on the ground or is caught, the vibration switch or the centrifugal switch are triggered again, and the velocity measuring device obtains the velocity of the baseball by calculating measured baseball running time via a calculator. But the velocity measuring device has the shortcoming of inaccurate velocity measuring. For example: when people wave arms to get ready to throw out the baseball, the vibration switch or the centrifugal switch can be touched when the people wave arms but the baseball does not move off the hand, and the velocity measuring device is caused to count time ahead of time to result in inaccurate measured baseball velocity; or a small child with weak force throws the baseball, because the throwing force is small, the baseball may moves off hands but the vibration switch or the centrifugal switch is not touched to cause the velocity measuring device not to work properly.

With the development of touch screen technology, an approach capacitive sensor is widely used in various touch screens as a touch switch. As a technology to support touch detection, the approach capacitive sensor reflects changes of surrounding materials by measuring capacitance and showing changes of the capacitance. A plurality of sensors measures changes by generating electric field and measuring attenuation which the electric field suffers. Different from an inductive sensor, the approach capacitive sensor can detect any conductive thing or anything different from sensor electrode environment dielectric properties. The approach capacitive sensor are excellent touch pad support tools, because the main component of our body is water which has high dielectric constant, and our bodies contain ionic substances which enable the human body to become a good conductor. When an object (such as a finger of a human body which is highly insulated and conductive) is near a metal electrode, an electrical path is formed, thereby resulting in changes of current in the electric field. Therefore, the inventor thinks of the ideas of applying the approach capacitive sensing technology to the velocity measuring device of the sports sphere and utilizing the approach capacitive sensor as a switch for the working of the trigger velocity measuring device.

### SUMMARY OF THE INVENTION

The purpose of the invention aims at the shortcoming existing in the prior art and provides a sphere with velocity measurement function, which utilizes an approach capacitive sensor as a switch for the trigger velocity measuring device to achieve more accurate measurement.

To achieve the purpose, the technical scheme adopted by the invention is:

A sphere with the velocity measurement function comprises a sphere and a velocity measuring device arranged in the sphere, the velocity measuring device comprises a base body, a speedometer and a power supply, the speedometer and the power supply are used for operation and control; the speedometer uses an approach capacitor sensor as a switch of a trigger circuit, the approach capacitor sensor comprises a sensing plate electrode, sensing plate electrode contacts and a conductive ink layer, the sensing plate electrode is arranged on the base body, the conductive ink layer is coated on the inner surface of the sphere, and the sensing plate electrode contacts are arranged in the conductive ink layer; when the base body is placed in the sphere, the conductive ink layer contacts the sensing plate electrode; the present invention also comprises a display screen for displaying results, the display screen transmits data with the speedometer in a wire or wireless way.

The display screen is electrically connected with the speedometer by a cable and is arranged on the surface of the sphere.

A wireless emitter for emitting data is arranged in the base body, the wireless emitter is electrically connected with the speedometer, a wireless receiver for receiving data is arranged in the display screen, and the display screen is arranged outside the sphere.

The outer shell of the base body is composed of an upper cover and a lower cover, the speedometer is fixed between the upper cover and the lower cover, and the power supply is fixed on the lower cover and is electrically connected with the speedometer.

The upper cover and the lower cover are fixedly connected in a buckle way.

The upper cover and the lower cover are fixedly connected by screw.

The display screen is a liquid crystal display screen.

The invention has the advantages that: the invention utilizes the approach capacitive sensor as a switch for the working of the trigger speedometer, when people holds the sphere by hand to accurately throw, hands touch the approach capacitive sensor; when the sphere breaks away from the hands, namely the sphere is thrown, the approach capacitive sensor feed backs the message of the baseball moving off the hand to the speedometer which then begins to count time; when the sphere is caught by people again, the approach capacitive sensor feed backs the message of the sphere being caught to the speedometer which then displays results on the display screen after analysis; and the speedometer is not influenced by the external force, reacts quickly, can obtain accurate measurement results and improve measurement accuracy.

### BRIEF DESCRIPTION OF THE DRAWINGS

FIG. 1 is a structural schematic diagram of the embodiment 1 of the invention;

FIG. 2 is a structural schematic diagram of the embodiment 2 of the invention;

FIG. 3 is an inner structural schematic diagram of sphere skins which composes the sphere of the invention;

FIG. 4 is a structural schematic diagram of the velocity measuring device of the invention;

FIG. 5 is a decomposed schematic diagram of the velocity measurement device of the embodiment 1 of the invention;

FIG. 6 is a decomposed schematic diagram of the velocity measurement device of the embodiment 2 of the invention; and

FIG. 7 is a structural schematic diagram of the display screen of the embodiment 2 of the invention.

### DESCRIPTION OF THE PREFERRED EMBODIMENT

The following is description of the technical scheme of the invention by combining the attached drawings:

### Embodiment 1

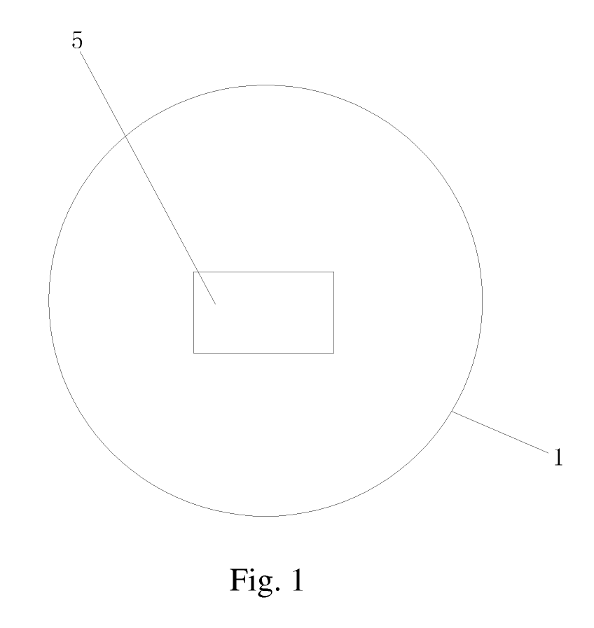

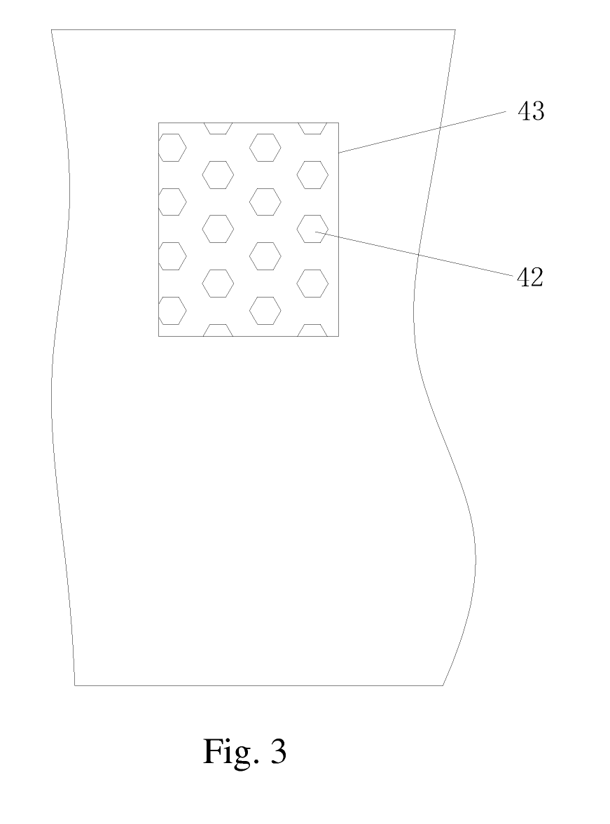

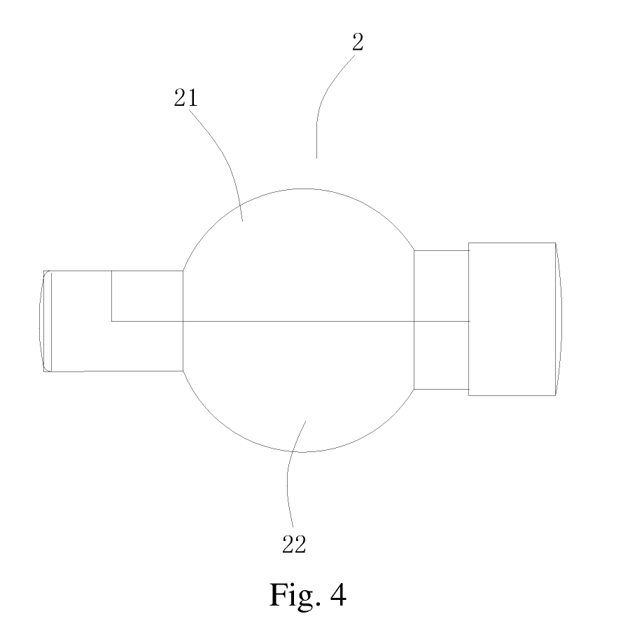

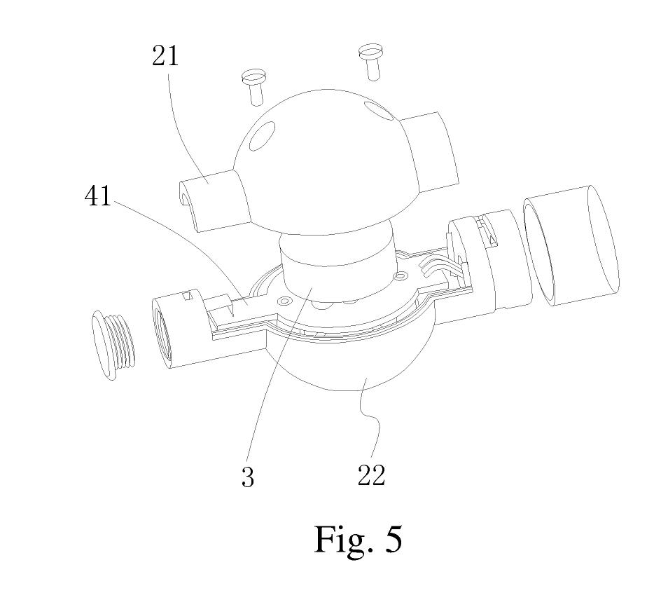

Referring to FIGS. 1, 3, 4 and 5, a sphere with velocity measurement function comprises a sphere 1 and a velocity measuring device arranged in the sphere 1, the velocity measuring device comprises a base body 2, a speedometer 3 and a power supply (not shown in the figure), and the speedometer 3 and the power supply are used for operation and control and are arranged in the base body 2; the speedometer 3 uses an approach capacitive sensor as a switch of a trigger circuit, the approach capacitive sensor comprises a sensing plate electrode 41, sensing plate electrode contacts 42 and a conductive ink layer 43, the sensing plate electrode 41 is arranged on the base body 2, the conductive ink layer 43 is coated on the inner surface of the sphere 1, and the sensing plate electrode contacts 42 are arranged on the conductive ink layer 43; when the base body 2 is arranged in the sphere 1, the conductive ink layer 43 contacts the sensing plate electrode 41; the present invention also comprises a display screen 5 for displaying results, which is a liquid crystal display screen, the display screen 5 is electrically connected with the speedometer 3 by a cable and is arranged on the surface of the sphere 1.

The outer shell of base body 2 is composed of an upper cover 21 and a lower cover 22, the speedometer 3 is fixed between the upper cover 21 and the lower cover 22, the power supply (not shown in the figure) is fixed on the lower cover 22 and is electrically connected with the speedometer 3.

The upper cover 21 and the lower cover 22 are fixedly connected in a buckle mode or by screw.

Working principle: when people hold the sphere in hands to throw accurately, hands touch the approach capacitive sensor; when the sphere moves off the hands of the people, that is the sphere is thrown away, the approach capacitive sensor feed backs the message of sphere moving off hands to the speedometer 3 which begins to count time, and when the sphere is caught by people again, the approach capacitive sensor feed backs the message of sphere having been caught to the speedometer 3 which then displays results on the display screen 5 after analysis.

### Embodiment 2

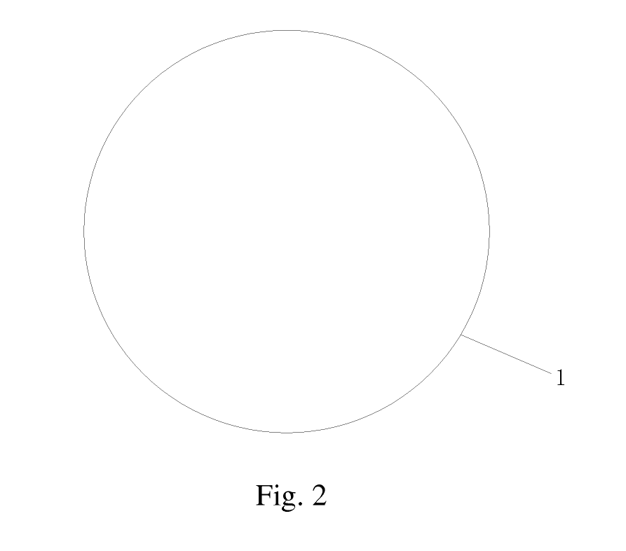

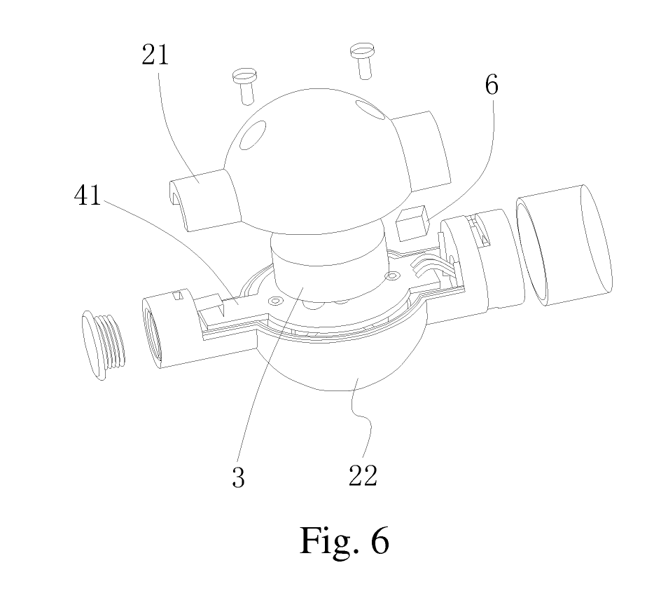

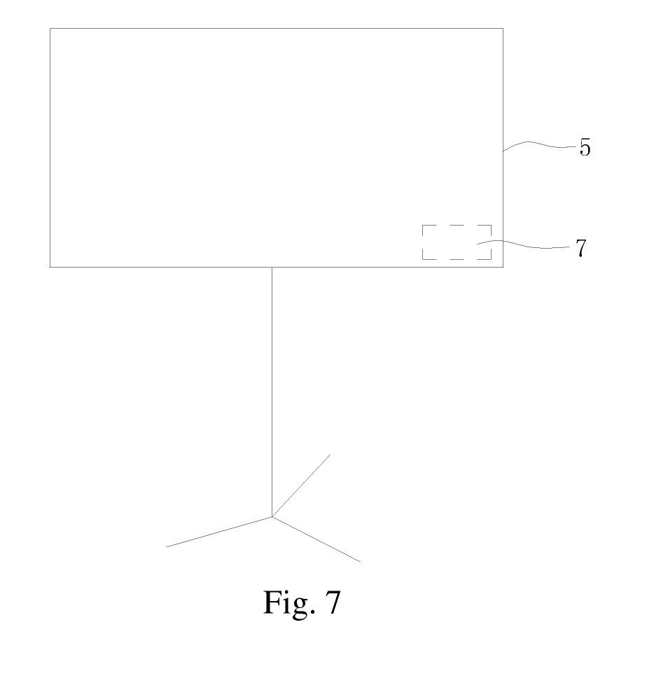

Referring to FIGS. 2, 3, 4, 6 and 7, a sphere with velocity measurement function comprises a sphere 1 and a velocity measuring device arranged in the sphere 1, the velocity measuring device comprises a base body 2, a speedometer 3 and a power supply (not shown in the figure), and the speedometer 3 and the power supply are used for operation and control; the speedometer 3 uses an approach capacitive sensor as a switch of a trigger circuit, the approach capacitive sensor comprises a sensing plate electrode 41, sensing plate electrode contacts 42 and a conductive ink layer 43, the sensing plate electrode 41 is arranged on the base body 2, the conductive ink layer 43 is coated on the inner surface of the sphere 1, and the sensing plate electrode contacts 42 are arranged on the conductive ink layer 43; when the base body 2 is arranged in the sphere 1, the conductive ink layer 43 contacts the sensing plate electrode 41; the present invention also comprises a display screen 5 for displaying results; a wireless emitter 6 for emitting data is arranged in the base body 2 and is electrically connected with the speedometer 3; a wireless receiver 7 for receiving data is arranged in the display screen 5 which is arranged outside the sphere 1, and the display screen 5 is generally a large scale LED display screen erected in a prominent position for audience to read conveniently.

The outer shell of the base body 2 is composed of an upper cover 21 and a lower cover 22, the speedometer 3 is fixed between the upper cover 21 and the lower cover 22, and the power supply (not shown in the figure) is fixed on the lower cover 22 and is electrically connected with the speedometer 3.

The upper cover 21 and the lower cover 22 are fixedly connected in a buckle way or by screw.

Working principle: when people hold the sphere 1 in hands to throw accurately, hands touch the approach capacitive sensor; when the sphere moves off the hands of the people, that is the sphere is thrown away, the approach capacitive sensor feed backs the message of sphere moving off hands to the speedometer 3 which begins to count time; when the sphere is caught by people again, the approach capacitive sensor feed backs the message of sphere having been caught to the speedometer 3 which emits results in a wireless signals mode by the wireless emitter 6 after analysis, and a wireless receiver 7 on the display screen 5 receives signals emitted by the wireless emitter 6, then converts the data, and displays results on the display screen 5.

Finally, it should be explained that the embodiments are only used to describe the technical scheme of the invention but not restriction to the protective scope of the invention. Although the invention is described in detail by referring to better embodiments, ordinary technical staff in the field should understand the technical scheme of the invention can be modified or replaced similarly, and the essence and scope can not be broke away.

What is claimed is:

1. A sphere with velocity measurement function comprising a sphere and a velocity measuring device arranged in the sphere, the velocity measuring device comprising a base body, a speedometer and a power supply, the speedometer and the power supply mounted in the base body and used for operation and control;
the speedometer using an approach capacitor sensor as a switch of a trigger circuit, the approach capacitor sensor comprising a sensing plate electrode, sensing plate electrode contacts and a conductive ink layer, the sensing plate electrode arranged on the base body, the conductive ink layer coated on the inner surface of the sphere, and the sensing plate electrode contacts arranged in the conductive ink layer,
when the base body is placed in the sphere, the conductive ink layer contacts the sensing plate electrode; the sphere further comprises a display screen for displaying results, and the display screen transmits data with the speedometer in a wire or wireless way.

2. The sphere with velocity measurement function of claim 1, wherein the display screen is electrically connected with the speedometer by a cable and is arranged on the surface of the sphere.

3. The sphere with velocity measurement function of claim 1, wherein a wireless emitter for emitting data is arranged in the base body, the wireless emitter is electrically connected with the speedometer, a wireless receiver for receiving data is arranged in the display screen, and the display screen is arranged outside the sphere.

4. The sphere with velocity measurement function of claim 1, wherein the outer shell of the base body is composed of an upper cover and a lower cover, the speedometer is fixed between the upper cover and the lower cover, and the power supply is fixed on the lower cover and is electrically connected with the speedometer.

5. The sphere with velocity measurement function of claim 4, wherein the upper cover and the lower cover are fixedly connected in a buckle way.

6. The sphere with velocity measurement function of claim 4, wherein the upper cover and the lower cover are fixedly connected by screw.

7. The sphere with velocity measurement function of claim 1, wherein the display screen is a liquid crystal display screen.
